(19) United States
(12) Patent Application Publication
(10) Pub. No.: US 2024/0091927 A1
(43) Pub. Date: Mar. 21, 2024

(54) TEACHING DEVICE

(71) Applicant: FANUC CORPORATION, Yamanashi (JP)

(72) Inventors: Misaki ITO, Yamanashi (JP); Yuta NAMIKI, Yamanashi (JP)

(21) Appl. No.: 18/254,880

(22) PCT Filed: Jan. 24, 2022
(86) PCT No.: PCT/JP2022/002464

§ 371 Date: May 30, 2023

(30) Foreign Application Priority Data
Jan. 28, 2021 (JP) 2021-011999

(51) Int. Cl. B25J 9/00; B25J 9/16; B25J 13/08

(52) U.S. Cl. CPC B25J 9/0081; B25J 9/1656; B25J 13/08

(57) ABSTRACT

A teaching device for creating a control program for a robot includes: a screen generation unit which generates a program creation screen for creating a program via commands representing functions constituting the control program for the robot; and a related information display control unit which, in accordance with the selection of or an execute instruction for a command disposed in the program creation screen, displays information relating to the command subject to the selection or the execute instruction.

### FIELD

The present invention relates to a teaching device.

### BACKGROUND

A teaching device that can perform programming using an icon representing each command of robot control has been proposed (for example, PTL 1). Further, in relation to this, PTL 2 describes a configuration in which, when a setting menu on a touch panel is selected in a teaching device for performing input (setting) work of various types of teaching data such as selection of an operation method and a movement point of a robot body, an item selection screen representing a plurality of teaching items by icons is displayed, and a video that expresses a content of the teaching item in each of the icons is also displayed (Abstract).

### CITATION LIST

### Patent Literature

[PTL 1] Japanese Patent No. 6498366 B1
[PTL 2] Japanese Unexamined Patent Publication (Kokai) No. 2001-88068 A

### SUMMARY

### Technical Problem

In general, in teaching (programming) using an icon in a conventional teaching device, unless an operation of selecting the icon on a program creation screen and opening a parameter setting screen for setting a parameter of the icon is performed, setting information about the icon cannot be confirmed. Further, in the teaching (programming) using the icon, not only the setting information displayed on the parameter setting screen but also information about a sensor related to the icon, an execution result of the icon, and the like should be confirmed in many cases.

### Solution to Problem

An aspect of the present disclosure is a teaching device configured to create a control program of a robot including: a screen generation unit configured to generate a program creation screen for performing program creation by a command representing a function constituting a control program of the robot; and a related information display control unit configured to display, in response to selection or an execution instruction on a command disposed in the program creation screen, information related to a command being a target of the selection or the execution instruction.

### Advantageous Effects of Invention

According to the configuration described above, in programming of a control program of a robot, various types of information that assist in the programming are provided through an extremely simple operation, and more intuitive and efficient programming can be performed.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is an overall configuration diagram of a robot system including a teaching device according to a first embodiment.

FIG. 2 is a diagram representing a state where a force sensor is disposed between a wrist flange and a hand of a robot.

FIG. 3 is a diagram representing a hardware configuration example of a visual sensor controller and a robot controller.

FIG. 4 is a functional block diagram of the visual sensor controller and the robot controller.

FIG. 5 is a diagram representing a hardware configuration example of the teaching device.

FIG. 6 is a functional block diagram of the teaching device.

FIG. 7 is a diagram being an operation example of Example 1 and representing a state where a live image of a visual sensor is displayed by selection of a view icon disposed in an icon display region.

FIG. 8 is a diagram being an operation example of Example 1 and representing a state where the live image of the visual sensor is displayed by selection of the view icon disposed in a program creation region.

FIG. 9 is a diagram being an operation example of Example 2 and representing a state where information about a detection result is displayed as an execution result of the view icon disposed in the program creation region.

FIG. 10 is a diagram being an operation example of Example 3 and representing a state where information about the force sensor is displayed in response to selection of an icon related to a function of the force sensor in the icon display region.

FIG. 11 is a diagram being an operation example of Example 4 and representing an example in which information related to equipment connected to the robot is displayed in response to an execution instruction on an icon related to the equipment.

FIG. 12 is a diagram being an operation example of Example 5 and representing an example in which setting information about a waiting setting icon disposed in the icon display region is displayed in response to selection of the icon.

FIG. 13 is a diagram being an operation example of Example 5 and representing an example in which setting information about the waiting setting icon disposed in the program creation region is displayed in response to an execution instruction of the icon.

FIG. 14 is a diagram being an operation example of Example 5 and representing an example in which setting information about a linear movement icon disposed in the icon display region is displayed in response to selection of the icon.

FIG. 15 is a diagram being an operation example of Example 6 and representing an example in which an internal variable related to a register icon disposed in the icon display region is displayed in response to selection of the icon.

FIG. 16 is a diagram being an operation example of Example 6 and representing a display example when there is an error in setting of the register icon.

FIG. 17 is a diagram being an operation example of Example 7 and representing an example in which information related to an icon disposed in the program creation region is displayed at a point in time before execution of the icon in response to an execution instruction to a program of the icon.

FIG. 18 is a functional block diagram of a teaching device according to a second embodiment.

FIG. 19 is a diagram for describing switching of a display content according to display attribute information.

FIG. 20 is a diagram for describing switching of a display content according to an execution state attribute.

### DESCRIPTION OF EMBODIMENTS

Next, embodiments of the present disclosure will be described with reference to drawings. In referenced drawings, similar components or functional parts are given similar signs. In order to facilitate understanding, the drawings use different scales as appropriate. Further, embodiments illustrated in the drawings are an example for implementing the present invention, and the present invention is not limited to the illustrated embodiments.

### First Embodiment

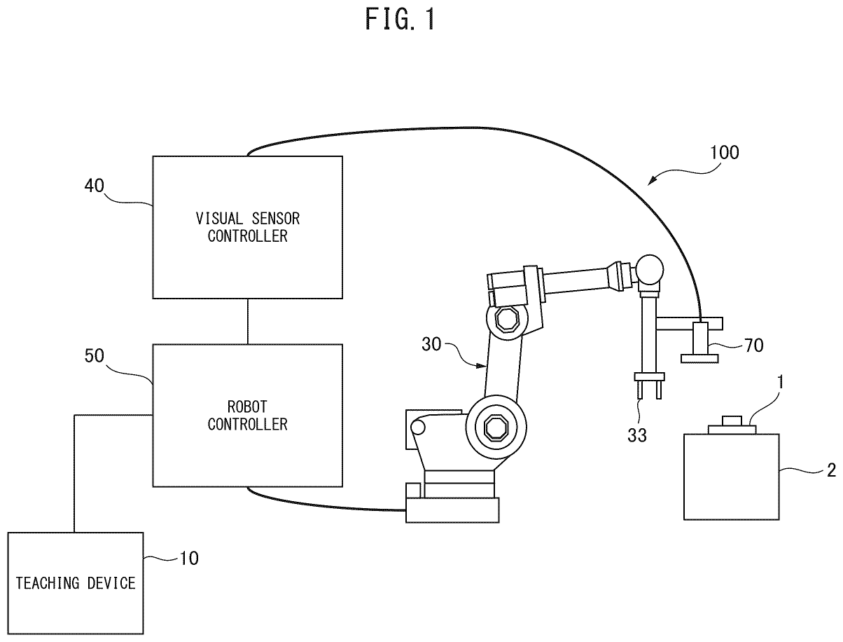

FIG. 1 is a diagram representing an overall configuration of a robot system 100 including a teaching device 10 according to an embodiment. As described below, the teaching device 10 is a teaching device for performing programming by a command representing a function constituting a control program of a robot. Hereinafter, as an exemplification, it is assumed that the teaching device 10 is a teaching device that can perform programming using an icon representing the function constituting the control program of the robot (i.e., representing the command of robot control). A robot system including the teaching device 10 may have various configurations, but, in the present embodiment, as an exemplification, the robot system 100 illustrated in FIG. 1 will be described. The robot system 100 includes a robot 30 installed with a hand 33 on an arm tip portion, a robot controller 50 that controls the robot 30, the teaching device 10 connected to the robot controller 50, a visual sensor 70 attached to the arm tip portion of the robot 30, and a visual sensor controller 40 that controls the visual sensor 70. The robot system 100 is configured to perform detection of an object 1 on a work table 2 by the visual sensor 70 and to perform handling of the object 1 by the hand 33 installed on the robot 30.

The visual sensor controller 40 has a function of controlling the visual sensor 70 and a function of performing image processing on an image captured by the visual sensor 70. The visual sensor controller 40 detects a position of the object 1 from the image captured by the visual sensor 70, and provides the detected position of the object 1 to the robot controller 50. In this way, the robot controller 50 can correct a teaching position and perform takeout and the like of the object 1.

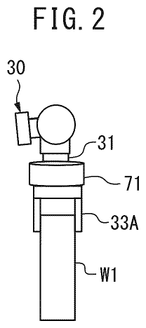

Note that FIG. 1 illustrates a configuration example in which the robot system 100 includes the visual sensor 70 as a sensor according to a function of the robot system, but various examples of the sensor according to the function of the robot system are possible. For example, when the robot system is installed with a force sensor, as illustrated in FIG. 2, a force sensor 71 may be disposed between a wrist flange 31 and a hand 33A of the robot 30. Note that, for convenience in description, FIG. 2 illustrates only a vicinity of the arm tip portion of the robot 30. Using the force sensor 71 can cause the robot 30 to perform work (for example, precision fitting work) for pressing a workpiece Wi against another workpiece with a fixed force, and the like.

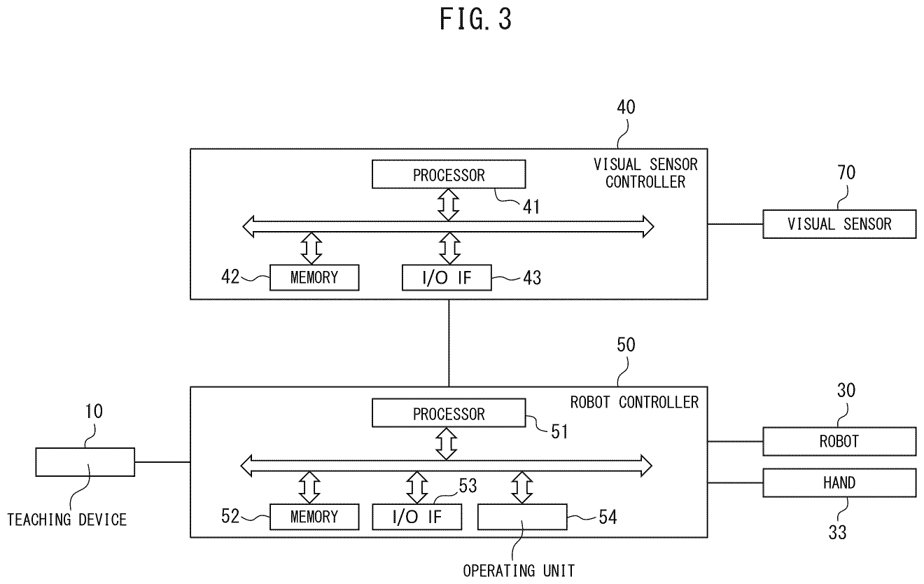

FIG. 3 is a diagram representing a hardware configuration example of the visual sensor controller 40 and the robot controller 50. As illustrated in FIG. 3, the visual sensor controller 40 may have a configuration as a general computer in which a memory 42 (such as a ROM, a RAM, and a non-volatile memory), an input-output interface 43, and the like are connected to a processor 41 via a bus. Further, the robot controller 50 may have a configuration as a general computer in which a memory 52 (such as a ROM, a RAM, and a non-volatile memory), an input-output interface 53, an operating unit 54 including various operating switches, and the like are connected to a processor 51 via a bus.

The visual sensor 70 may be a camera that captures a gray-scale image and a color image, or may be a stereo camera or a three-dimensional sensor that can acquire a distance image and a three-dimensional point group. A plurality of the visual sensors may be disposed in the robot system 100. The visual sensor controller 40 holds a model pattern of an object, and performs image processing of detecting the object by pattern matching of an image of the object in a captured image with the model pattern. Note that FIG. 1 illustrates an example in which the visual sensor 70 is attached to the arm tip of the robot 30, but the visual sensor 70 may be fixed in a known position in which the object 1 on the work table 2 can be captured in a work space. Alternatively, a configuration example is also possible in which detection, inspection, and the like of the object 1 are performed by performing, by the robot 30, an operation of holding the object 1 and presenting the object to the visual sensor fixedly installed in the work space.

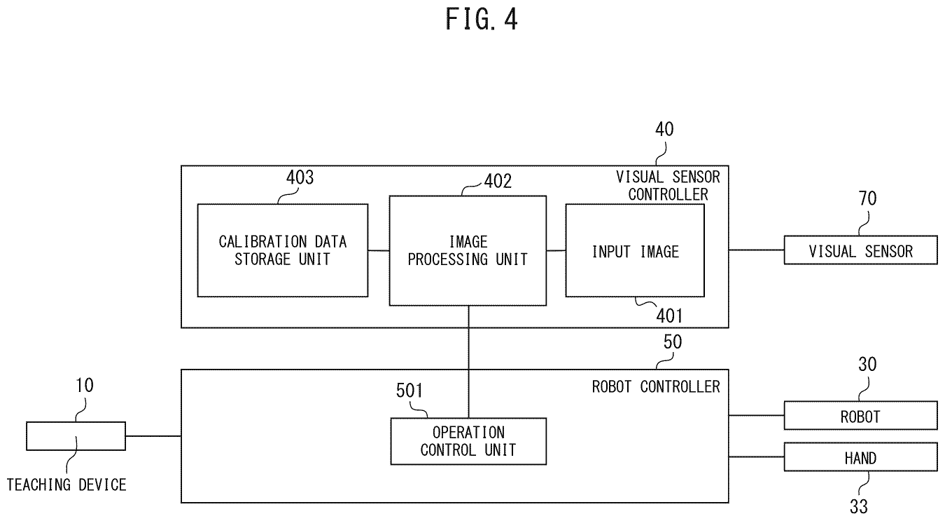

FIG. 4 is a functional block diagram representing a main functional block of the visual sensor controller 40 and the robot controller 50. As illustrated in FIG. 4, the visual sensor controller 40 includes an image processing unit 402 that performs image processing on an input image 401 captured by the visual sensor 70, and a calibration data storage unit 403 that stores calibration data that determine a relative position of the visual sensor 70 with respect to a reference coordinate system set in the robot 30. As an example, the image processing unit 402 performs image processing of detecting the object 1 from an input image by the pattern matching using the model pattern.

The robot controller 50 includes an operation control unit 501 that controls an operation of the robot 30 according to an operation command input from the teaching device 10 or a control program held in an internal memory. As an example, the image processing unit 402 provides a detected position of the object 1 to the operation control unit 501, and the operation control unit 501 performs handling of the object 1 by using the detected position provided from the image processing unit 402.

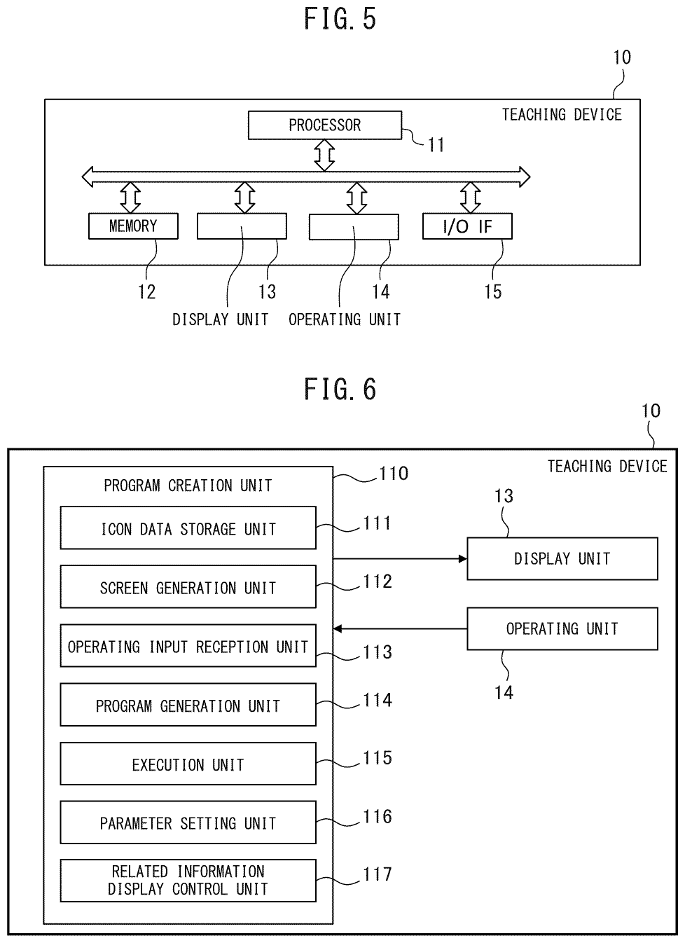

The teaching device 10 is used for teaching the robot 30 (i.e., creating a control program). Various information processing devices such as a teach pendant, a tablet terminal, a smartphone, and a personal computer can be used as the teaching device 10. FIG. 5 is a diagram representing a hardware configuration example of the teaching device 10. As illustrated in FIG. 5, the teaching device 10 may have a configuration as a general computer in which a memory 12 (such as a ROM, a RAM, and a non-volatile memory), a display unit 13, an operating unit 14 formed of an input device such as a keyboard (or a software key), an input-output interface 15, and the like are connected to a processor 11 via a bus.

As will be described in detail below, the teaching device 10 is configured to be able to perform programming by an icon representing a function constituting the control program of the robot 30. FIG. 6 is a functional block diagram of the teaching device 10. As illustrated in FIG. 6, the teaching device 10 includes a program creation unit 110 for performing creation and editing of the control program by the icon. The program creation unit 110 includes an icon data storage unit 111 that stores data about the icon, a screen generation unit 112 that generates various screens for control program creation, an operating input reception unit 113 that receives various user operations for the creation and the editing of the control program, a program generation unit 114, an execution unit 115, a parameter setting unit 116, and a related information display control unit 117.

The icon data storage unit 111 is formed of, for example, a non-volatile memory, and stores various types of information related to the icon. The information related to the icon includes information related to a design of the icon, a parameter (setting information) set for a function of the icon, a character string that briefly represents the function of the icon, and the like. Note that a default value may be set as parameter setting of each of the icons in the icon data storage unit 111.

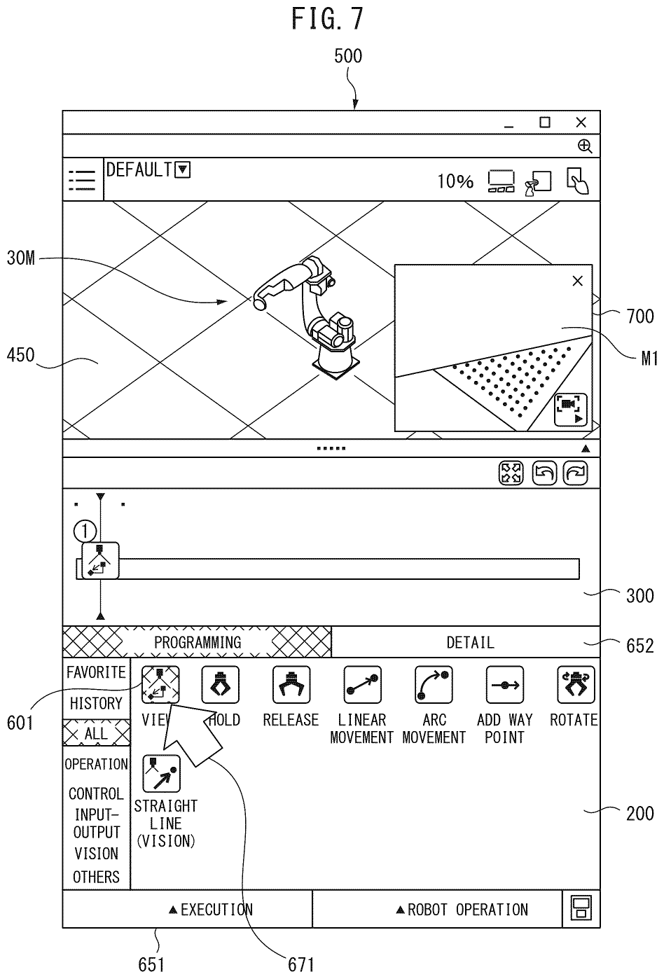

The screen generation unit 112 generates a program creation screen 500 for performing the creation of the control program using the icon. As illustrated in FIG. 7 as an example, the program creation screen 500 includes a first region (icon display region 200) that displays a list of one or more icons representing a function constituting the control program of the robot 30, a second region (program creation region 300) for creating the control program by disposing the icon selected from the first region. In the program creation screen 500 as exemplified in FIG. 7, a user selects a desired icon from the icon display region 200 and arranges the icon in the program creation region 300. Then, the user sets a parameter related to the function of each of the icons disposed in the program creation region 300 as necessary. In this way, the user can create the control program without a need for knowledge of a syntax of a program language.

The operating input reception unit 113 receives various operating inputs to the program creation screen 500. For example, the operating input reception unit 113 assists in the operating input in which one of the icons disposed in the icon display region 200 or the program creation region 300 is selected in response to an operation of a cursor of the input device being positioned on the icon, and the icon disposed in the icon display region 200 is dragged, dropped, and arranged in the program creation region 300.

The program generation unit 114 generates the control program by a program language from one or more icons disposed in an operation order in the program creation region 300.

The execution unit 115 executes the icon in response to a user operation of instructing execution of the icon disposed in the program creation region 300. The execution unit 115 can collectively execute the icons disposed in the program creation region 300, or can execute one or a plurality of the icons in the program creation region 300. As an exemplification, the execution unit 115 may be configured to execute, in order, the icon arranged in the program creation region 300 when an execution tab 651 (see FIG. 7) is operated in a state where the icon is arranged in the program creation region 300, or to execute the icon in response to execution of an operation of selecting the icon and instructing execution in the program creation region 300 (an operation of locating the cursor and clicking (or an operation of tapping)). Note that the execution instruction to the icon (program) is not limited to the case of the user operation. For example, the icon (program) may be executed by a signal input from the outside to the teaching device (for example, a signal input from various types of equipment to the robot 30 or the robot controller 50).

The parameter setting unit 116 provides a function of performing parameter setting to the icon selected in the program creation region 300 or the icon display region 200. For example, the parameter setting unit 116 generates a screen for performing a parameter input and receives a parameter setting input when a detail tab 652 (see FIG. 7) is selected in a state where the icon is selected. For example, the parameter setting herein is as follows.

A “view icon” corresponding to a detection function using the visual sensor:
Initial setting of a camera
Teaching setting of an object
Setting of a capturing position

A “linear movement icon” corresponding to a function of a linear movement:
Operation speed
Positioning setting
A specification of a position register

Note that, as described above, a default value may be set in the parameters in advance.

In response to at least either a selection operation on the icon in the icon display region 200 or the program creation region 300, or an operation of instructing execution on the icon disposed in the program creation region 300, the related information display control unit 117 displays, on a display screen of the display unit 13, information related to the target icon of the selection operation or the operation of instructing the execution. The information related to the icon includes any of parameter setting information about the icon, information about a sensor or equipment associated with the icon, an execution result of the icon or a state during execution of the icon, an internal variable of a program according to the icon, and the like.

Hereinafter, Examples of a display of various types of information in response to an operation of selecting the icon and an operation of instructing execution via the program creation screen 500 by the teaching device 10 will be described.

### Example 1

Example 1 will be described with reference to FIG. 7. Example 1 is an example of displaying information about a sensor related to an icon in response to the icon being selected in the icon display region 200 or the program creation region 300. It is assumed that a “view icon 601” is selected as an exemplification. The view icon 601 provides a function of detecting an object by the visual sensor 70 and acquiring position information about the object.

A basic configuration of the program creation screen 500 generated by the screen generation unit 112 will be described. As illustrated in FIG. 7, the program creation screen 500 includes the icon display region 200 that displays a list of various icons that can be used for program creation, and the program creation region 300 for disposing the icons in an operation order and creating a control program. In response to a selection operation of the icon or an operation of instructing execution of the icon, a pop-up screen 700 that displays information related to the icon is displayed. The pop-up screen 700 is preferably displayed as a screen (window) different from the icon display region 200 and the program creation region 300 (in such a way as not to overlap the regions). Note that a form in which the information related to the icon is displayed is not limited to the pop-up screen, and various display forms can be adopted.

The program creation screen 500 may further include a state display region 450. Note that Examples 1 to 7 illustrate an example of displaying, in the state display region 450, a robot model 30M representing a current position posture of the robot 30. Note that an image of such a robot model 30M can be achieved by acquiring current position posture information about the robot 30 from the robot controller 50 in the teaching device 10 and operating 3D model data about the robot 30 in a virtual work space according to the position posture information.

In an operation of Example 1 illustrated in FIG. 7, the view icon 601 is selected by locating a cursor 671 on the view icon 601 in the icon display region 200. Note that, during an operation of selecting a target icon in the icon display region 200, dragging and dropping the icon, and disposing the icon in the program creation region 300, the icon may also be in a state of being selected.

In response to the selection of the view icon 601 in the icon display region 200, the related information display control unit 117 displays, on the pop-up screen 700, a live image M1 of a captured region of the visual sensor 70 as information about the visual sensor 70 associated with the view icon 601. A user can immediately confirm what is viewed in a visual field of the visual sensor 70 associated with the view icon 601, whether an object is correctly disposed in the visual field of the visual sensor, and the like by confirming such a live image M1. The live image M1 is immediately displayed by the user only selecting the view icon 601 for program creation, and thus the user does not need to perform a complicated operation in order to confirm an image of the visual field of the visual sensor 70.

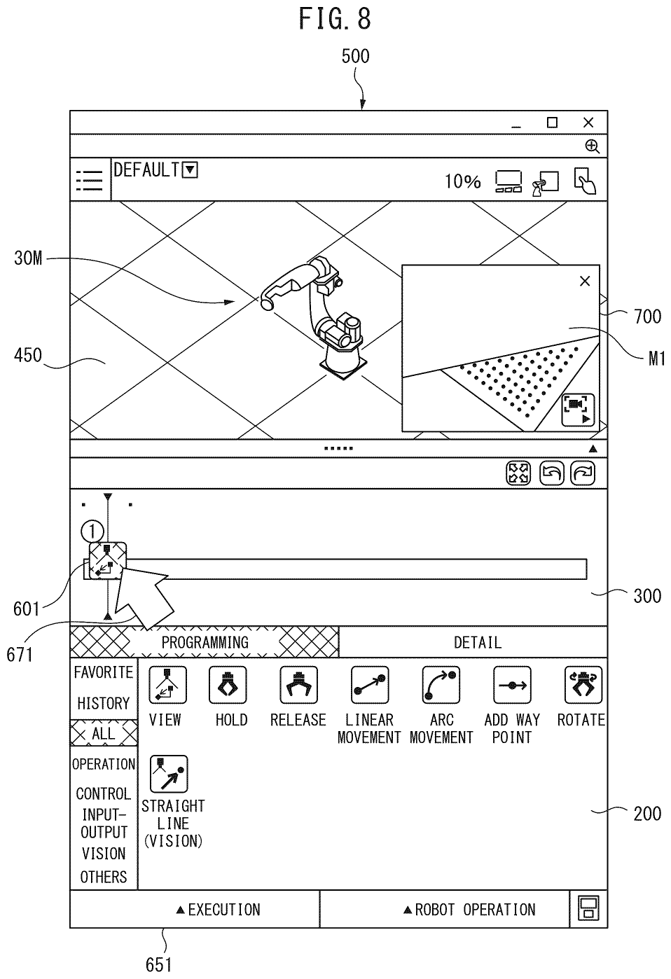

Further, as illustrated in FIG. 8, the related information display control unit 117 may display the pop-up screen 700 representing the live image M1 of the visual sensor 70 in response to selection of the view icon 601 disposed in the program creation region 300.

As illustrated in FIGS. 7 and 8, while a target icon (the view icon 601 herein) is selected, the icon is highlighted. While the target icon is selected, the related information display control unit 117 may display information (the live image M1 herein) related to the icon on the pop-up screen 700.

According to such Examples, the information related to the icon is displayed in a pop-up display separately from the program creation screen and a parameter setting screen, and thus a user can perform program creation while recognizing the entire program creation region 300 and also confirming the information related to the icon. In programming using the icon, various types of information that assists in the programming are provided through an extremely simple operation, and more intuitive and efficient programming can be performed. Such an effect according to Example 1 is also common to each Example described below.

### Example 2

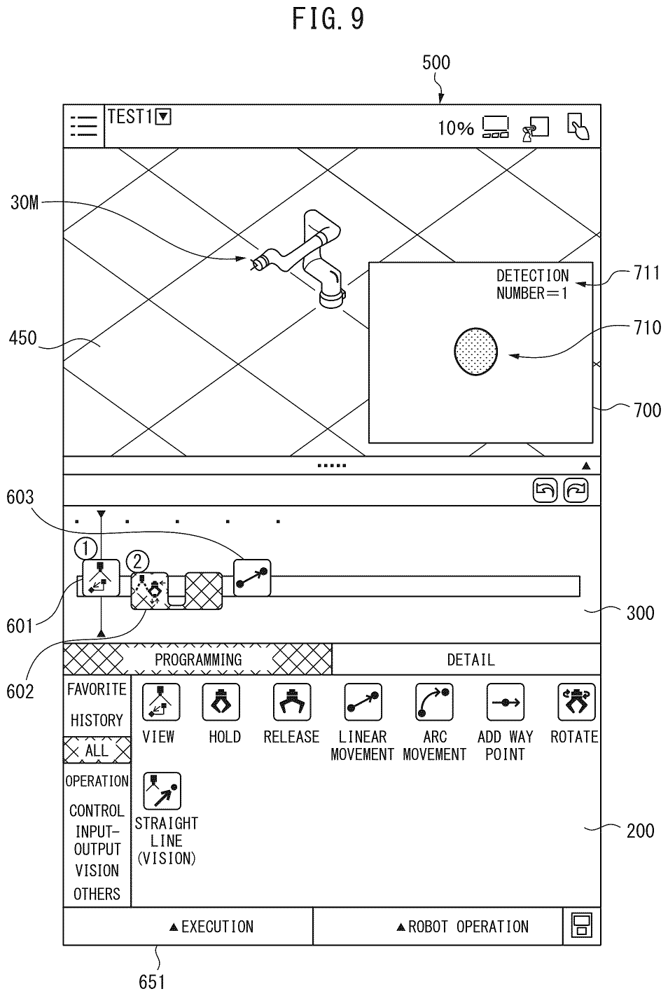

Example 2 will be described with reference to FIG. 9. Example 2 is an example of displaying information about an execution result of an icon disposed in the program creation region 300 when an operation of instructing execution is performed on the icon. In the program creation screen 500 illustrated in FIG. 9, the view icon 601, an operation (vision) icon 602, and a linear movement icon 603 are disposed in the program creation region 300 by a user operation. Note that the operation (vision) icon 602 provides a function of moving the robot 30 (a control portion) to a position detected by the view icon 601 and taking out an object. The linear movement icon 603 provides a function of linearly moving the robot 30 (control portion). It is assumed herein that the user performs an operation of selecting the view icon 601 in the program creation region 300 and executing the view icon 601 (for example, an operation of locating the cursor on the view icon 601 and clicking (or tapping) the view icon 601).

In response to execution completion of the view icon 601, the related information display control unit 117 causes the pop-up screen 700 to display an image of a detection result by the visual sensor 70 (visual sensor controller 40). As illustrated in FIG. 9, an image 710 of a detected object 1 and character information 711 (“DETECTION NUMBER=1”) representing the number of detected objects are displayed in the pop-up screen 700.

Note that the operation example when an execution result of the view icon 601 is displayed in response to the operation of selecting and executing the view icon 601 has been described herein, but, when execution on all icons disposed in the program creation region 300 in FIG. 9 is instructed by selection of the execution tab 651, the execution result may be displayed in response to execution completion of the view icon 601.

In this way, according to the present Example, only by performing the operation of instructing execution on an icon according to the visual sensor or a program including the icon according to the visual sensor in the program creation screen 500, a user can quickly confirm an execution result of the icon (i.e., a detection result indicating presence or absence of a taught object).

### Example 3

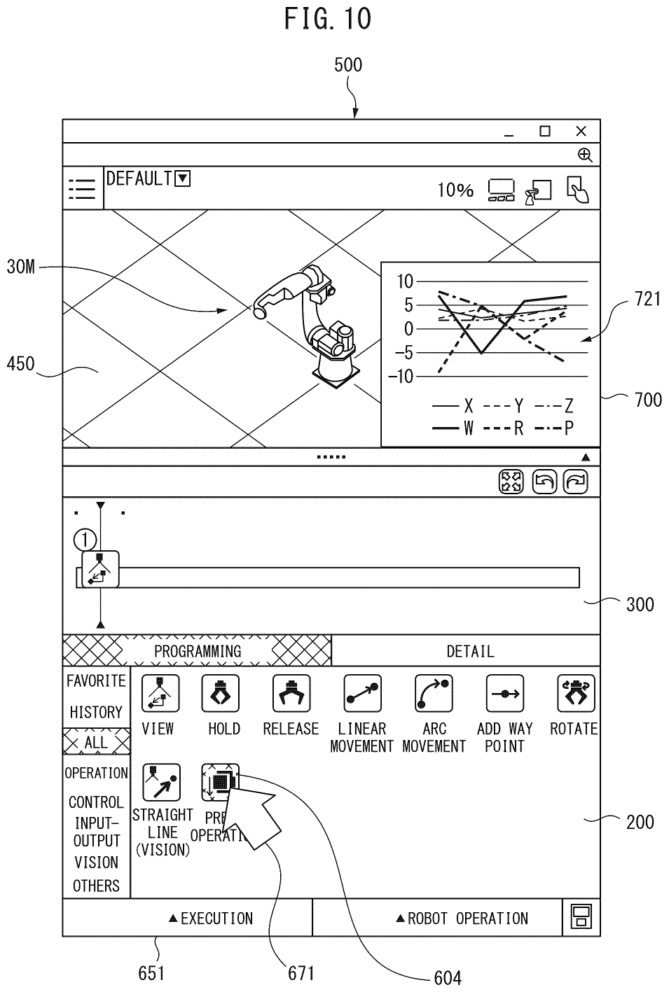

Example 3 will be described with reference to FIG. 10. Example 3 is an example of displaying information about a force sensor related to an icon related to a function using the force sensor in response to the icon being selected or instructed for execution in the icon display region 200. Note that, in the present Example, a case is assumed where the force sensor 71 is disposed in the robot system 100 as illustrated in FIG. 2. As illustrated in FIG. 10, it is assumed that a “press operation icon 604” related to force control using the force sensor 71 is selected in the icon display region 200. It is assumed that the force sensor 71 is a six-axis force sensor.

In this case, the related information display control unit 117 displays a graph 721 representing a detection value of the force sensor 71 on the pop-up screen 700 in response to selection of the press operation icon 604. The graph 721 indicates, as an output value of the force sensor 71, a time transition of magnitude of a load (X, Y, Z) in XYZ axis directions in a coordinate system set in the force sensor 71 and a moment (W, P, R) about the XYZ axes. Note that, in the graph 721, a vertical axis represents magnitude of the load or the moment, and a horizontal axis represents the time.

In this way, according to the present Example, a user can immediately confirm a current detection value of the force sensor only by selecting the icon related to the force sensor in the program creation screen 500.

Note that the operation example in which the graph 721 of the detection value of the force sensor 71 is displayed in response to selection of the press operation icon 604 displayed in the icon display region 200 has been described above, but, in response to an operation of selecting and instructing execution on the press operation icon 604 disposed in the program creation region 300, the graph 721 of the detection value of the force sensor 71 may be displayed, on the pop-up screen 700, as information related to a state during the execution while the press operation icon 604 is executed or information related to an execution result after the execution.

According to the present Example, a control program according to force control can be more intuitively and efficiently created.

### Example 4

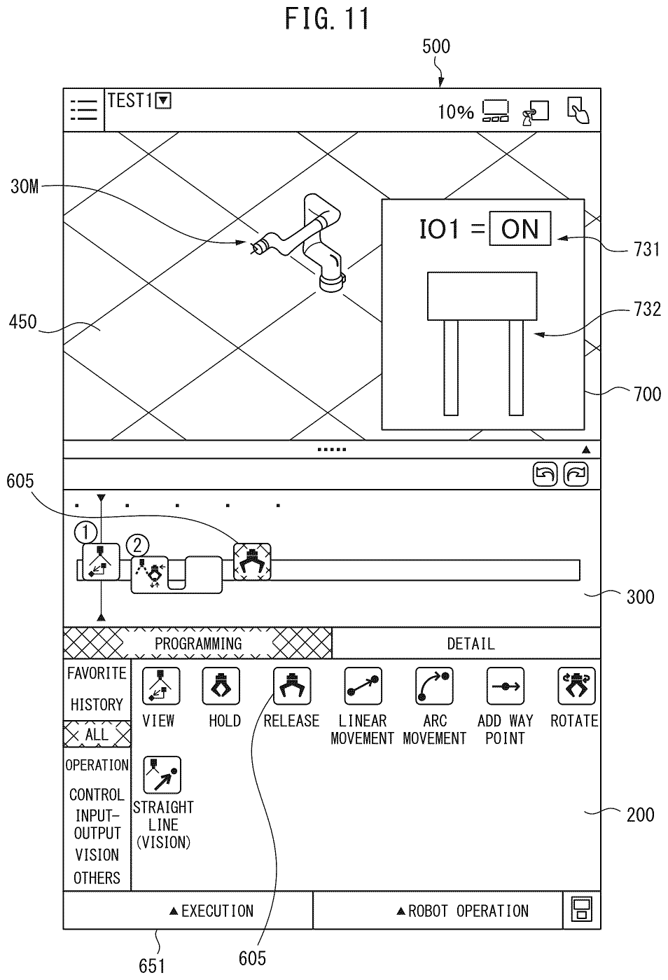

Example 4 will be described with reference to FIG. 11. Example 4 is an example of displaying information related to equipment (I/O equipment) connected to the robot 30 (robot controller 50) in response to selection or an execution instruction on an icon related to the equipment. A state is assumed where selection and an execution instruction are performed on a “release icon 605” of icons disposed in the program creation region 300 in the program creation screen 500 in FIG. 11. The release icon 605 corresponds to a command for opening the hand 33.

In this case, the related information display control unit 117 displays IO information 731 representing a state of IO control of the hand 33, and a hand image 732 graphically indicating a current opening/closing state of the hand 33 on the pop-up screen 700 in response to an operation of the selection and the execution instruction on the release icon 605. For example, the IO information 731 representing a state of the IO control and the hand image 732 may be displayed in real time during the execution of the release icon 605, or may be displayed as information representing an execution result after the execution of the release icon 605. Note that, in FIG. 11, a display example when the IO information 731 related to the hand 33 is “IO1=ON” and the hand image 732 indicates a state of the open hand is described as an exemplification. The related information display control unit 117 can acquire information about the IO control from the robot controller 50. Alternatively, the teaching device 10 and the hand 33 may be configured to be directly connected, and the teaching device 10 may directly acquire a state of control of the hand 33 from the hand 33 (the control unit of the hand 33).

### Example 5

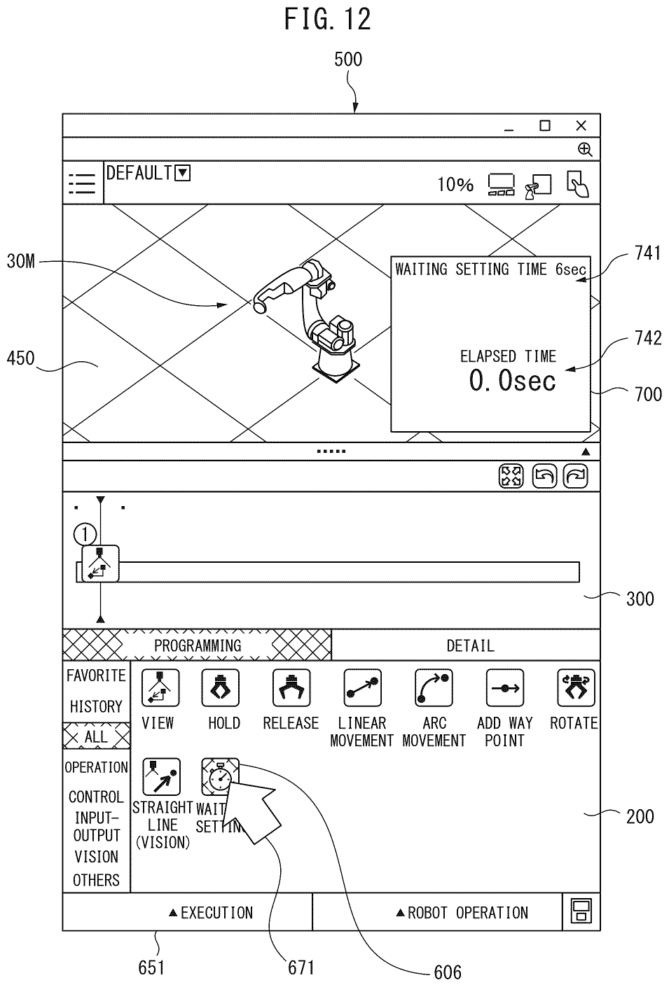

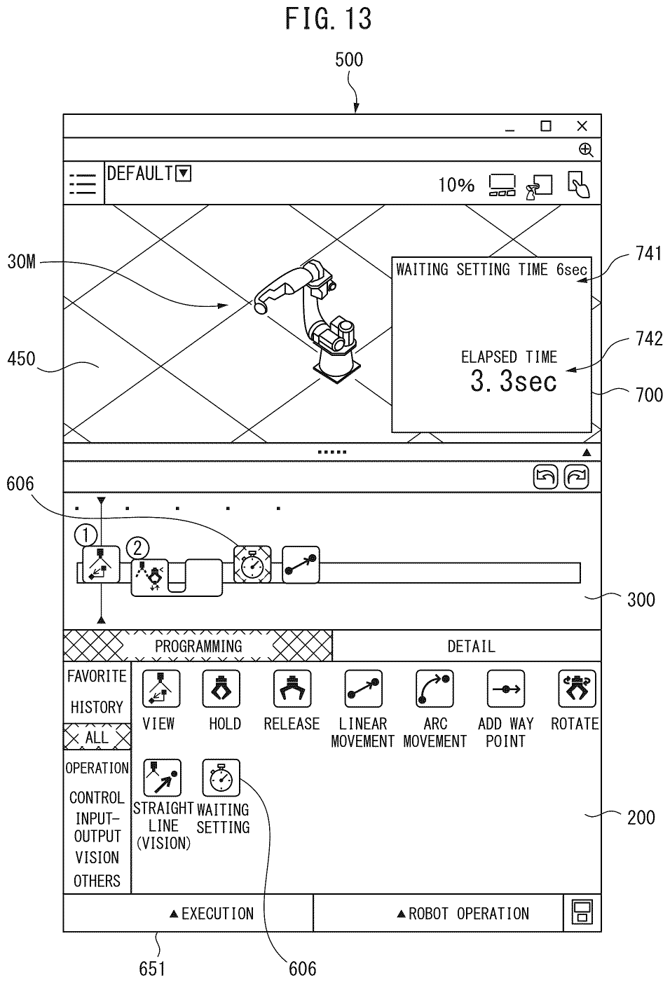

Example 5 will be described with reference to FIGS. 12 to 14. Example 5 is an example when a parameter (setting information) of an icon is displayed in response to selection or an execution instruction of the icon. FIGS. 12 to 13 illustrate an operation example when information related to an icon (a waiting setting icon 606) of a command for causing a program to wait for a specified time is displayed in response to selection or an execution instruction of the waiting setting icon 606.

In the program creation screen 500 illustrated in FIG. 12, the waiting setting icon 606 is selected in the icon display region 200. In response to the selection of the waiting setting icon 606, the related information display control unit 117 displays information 741 (“WAITING SETTING TIME 6 sec”) about a setting time of the waiting setting icon 606 on the pop-up screen 700. In this way, a user can confirm setting information about a target icon only by selecting the target icon. Note that “WAITING SETTING TIME 6 sec” displayed on the pop-up screen 700 in FIG. 12 is assumed to be a value set by the user in advance via the parameter setting screen. When the waiting setting icon 606 is selected in a state where setting of a waiting time by the user has not yet been performed, the related information display control unit 117 may display a default value (for example, 5 sec) of the waiting setting time as the information 741 about the setting time. Note that, in the pop-up screen 700 in FIG. 12, the waiting setting icon 606 is not operating, and thus elapsed time information 742 representing an elapsed time of an actual waiting time is displayed as 0.0 sec.

In the program creation screen 500 illustrated in FIG. 13, a user operation of instructing execution on four icons disposed in the program creation region 300 is performed, and the waiting setting icon 606 is currently executed. In this case, the related information display control unit 117 causes information related to setting of the waiting setting icon 606 and information related to the state during the execution of the icon to be displayed on the pop-up screen 700 in response to an execution start of the waiting setting icon 606. The related information display control unit 117 displays the elapsed time information 742 (“3.3 sec”) about the waiting time in real time, together with the information 741 (“WAITING SETTING TIME 6 sec”) about the setting time of the waiting setting icon 606. In this way, the user can confirm how long the robot 30 is stopped at a glance.

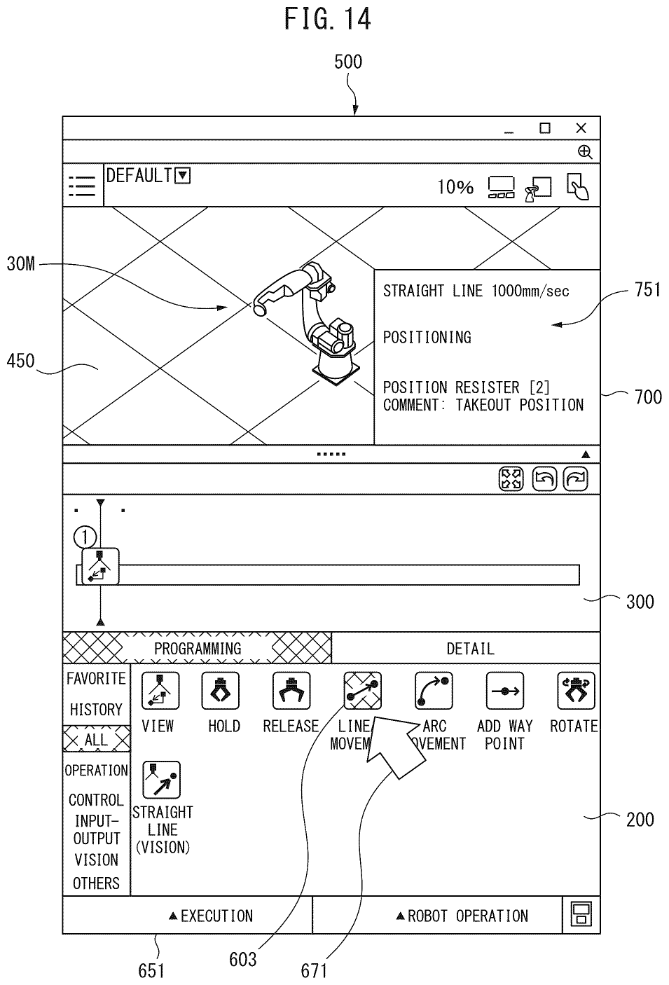

FIG. 14 illustrates an example when setting information related to the linear movement icon 603 corresponding to a command of a linear movement is displayed by selecting the linear movement icon 603 in the icon display region 200.

In the program creation screen 500 illustrated in FIG. 14, it is assumed that the linear movement icon 603 in the icon display region 200 is specified and selected by the cursor 671. In response to the selection of the linear movement icon 603, the related information display control unit 117 displays information 751 about a setting content of the linear movement icon 603 in the pop-up screen 700. The information 751 about the linear movement icon 603 includes an operation speed of the linear movement (1000 mm/sec), a specification of a “POSITIONING” operation of a stop at a target position after the movement, use of a position register [2] as a position specification, and a comment (“TAKEOUT POSITION”).

In this way, setting information about an icon is displayed, and thus a user can easily find a setting mistake. Thus, Example 5 assists a user who performs program creation (teaching), and makes programming more efficient.

### Example 6

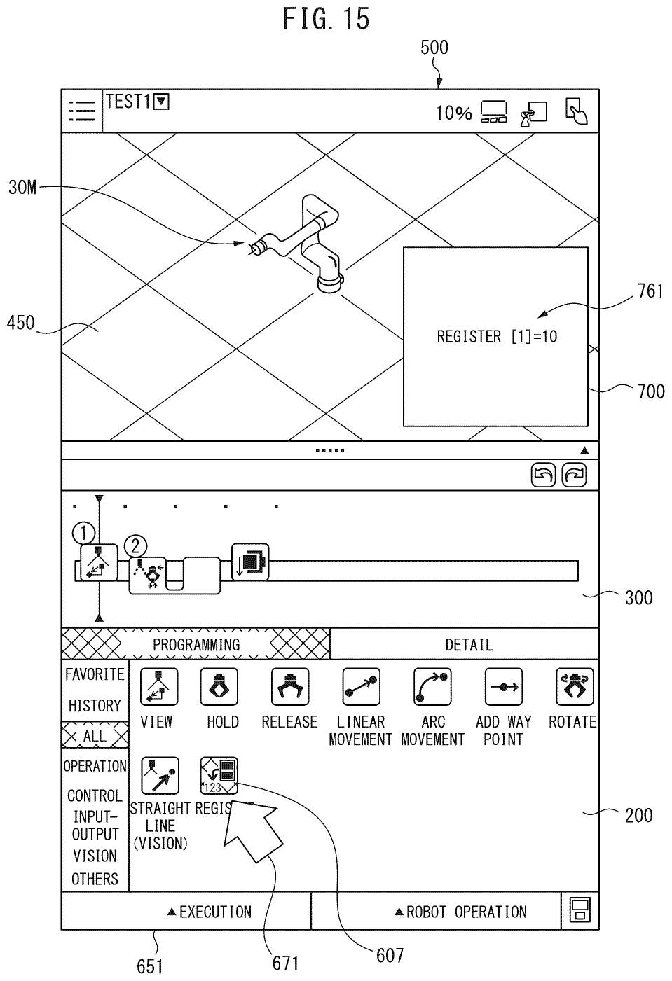

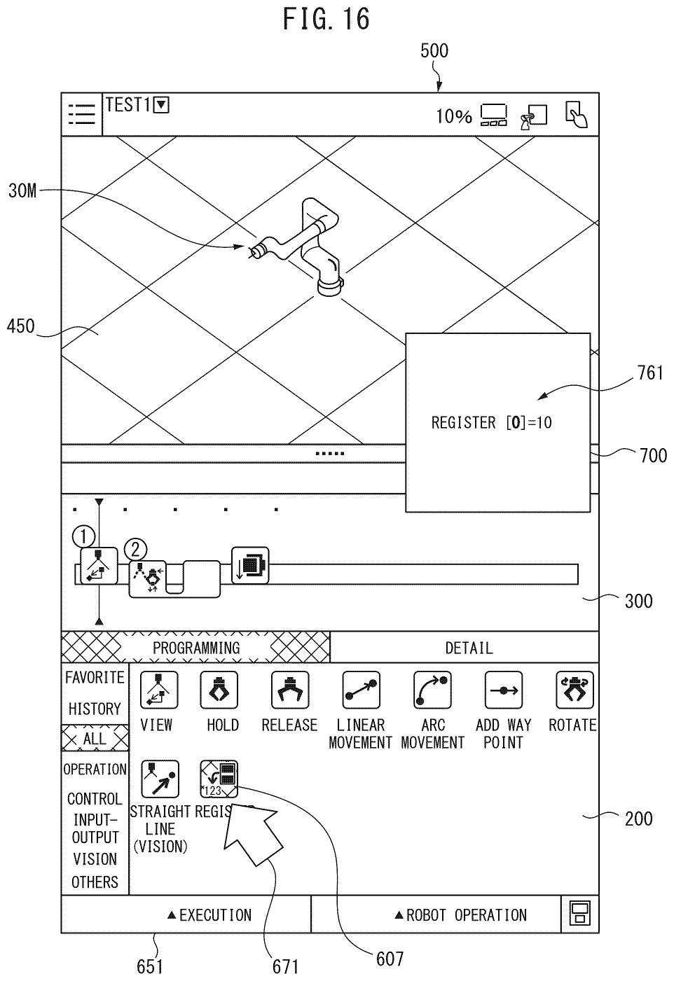

Example 6 will be described with reference to FIGS. 15 and 16. Example 6 relates to an operation example of displaying an internal variable of a program according to a target icon. A display of information when an icon (register icon 607) related to a register is selected will be described.

In the program creation screen 500 illustrated in FIG. 15, the register icon 607 is specified and selected by the cursor 671 in the icon display region 200. In response to the selection of the register icon 607, the related information display control unit 117 displays a value of a register (“REGISTER [1]=10”) as setting information 761 about the register icon 607 on the pop-up screen 700.

Note that, when there is an error in a setting content of the register icon 607, the related information display control unit 117 may display the error of the setting in the pop-up screen 700. In the example in FIG. 16, since an ineffective register number (register [0]) is specified in the setting of the register icon 607, the pop-up screen 700 illustrates a state where the register number “0” being an error is highlighted in red or another display aspect.

Note that the display of an internal variable of a program may also be displayed in a pop-up display during execution of the target icon or as an execution result after the execution.

According to the present Example, an internal variable of a program is provided, and error information is also provided when there is an error in setting of the variable and the like, and thus a user who performs program creation (teaching) can be assisted, and programming can be made more efficient.

### Example 7

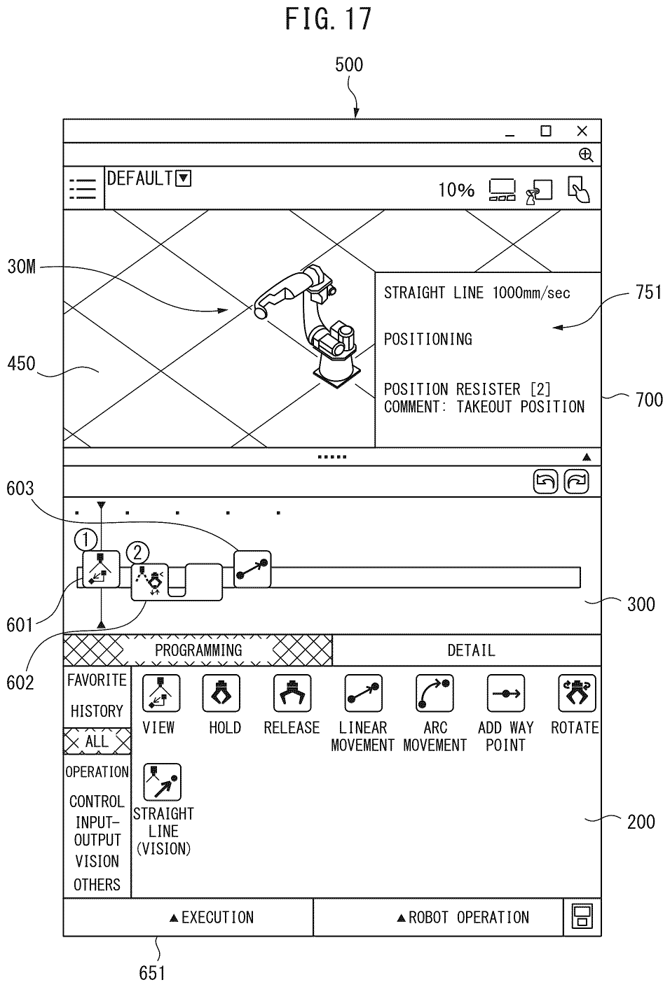

Example 7 will be described with reference to FIG. 17. Example 7 is an example in which, when an operation of instructing execution on a program of an icon disposed in the program creation region 300 is performed, information related to a certain icon is displayed in a pop-up display at a point in time before execution of the certain icon with regard to the certain icon.

As illustrated in FIG. 17, in the program creation screen 500, the view icon 601, the operation (vision) icon 602, and the linear movement icon 603 are disposed in the program creation region 300. It is assumed that the execution tab 651 is operated, execution of a program in the program creation region 300 is instructed, and the second operation (vision) icon 602 is currently being executed. By acquiring an execution state of the program from the execution unit 115, the related information display control unit 117 displays information related to the linear movement icon 603 in a pop-up display prior to a start of execution of the linear movement icon 603. FIG. 17 illustrates a situation where the information 751 about the setting content of the linear movement icon 603 is displayed during the execution of the operation (vision) icon 602.

Note that, in FIG. 17, the example in which information about one icon is provided before execution of the icon is described, but information about each of a plurality of icons included in the program creation region 300 may be provided before execution.

According to the present Example, since information related to an icon is displayed before execution of the icon, a user can recognize, in advance, the information related to the icon scheduled for a start of execution. For example, when a setting content of an icon scheduled to be executed has an error and the like, a response such as a stop of a program before the icon is executed can be made.

As described above, according to the present embodiment, in programming of a control program of a robot, various types of information that assists in the programming are provided through an extremely simple operation, and more intuitive and efficient programming can be performed.

### Second Embodiment

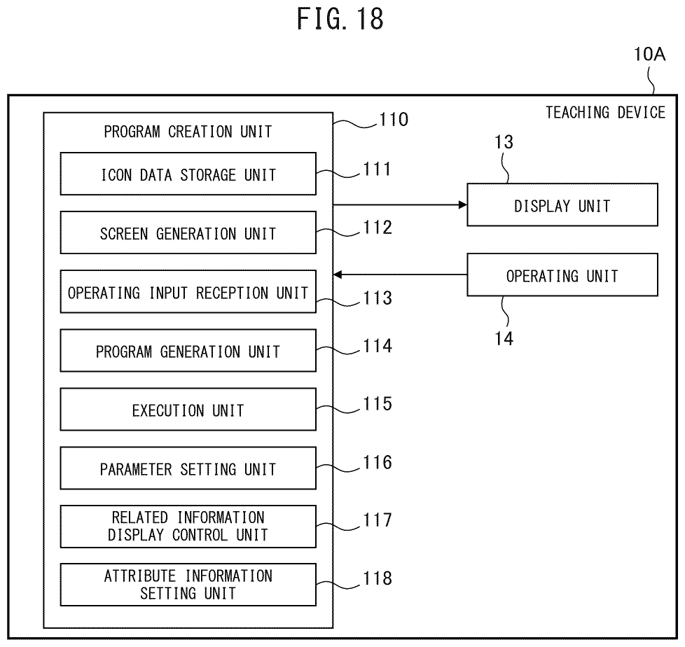

Next, a teaching device 10A according to a second embodiment will be described. As illustrated in FIG. 18, the teaching device 10A has a configuration in which an attribute information setting unit 118 is added to the teaching device 10 according to the first embodiment. The teaching device 10A has the function of the teaching device 10 described above. Note that a case is assumed where a robot system being a target of programming by the teaching device 10A is a welding robot system. The welding robot system can be achieved by a configuration of the robot system 100 illustrated in FIG. 1 in which a welding torch is attached to the arm tip portion of the robot 30 instead of the hand 33, a welding power source device that supplies a welding current to the welding torch is connected to the robot controller 50, and the welding power source device is operated under control of the robot controller 50. In the present embodiment, such a welding robot system is assumed.

The attribute information setting unit 118 provides a function of setting, for each icon, display attribute information that defines a display content needed to be displayed as information related to an icon. The set display attribute information is stored in association with the icon in an icon data storage unit 111. When the information related to the icon is displayed in response to an execution instruction on the icon, the related information display control unit 117 determines a display content according to the display attribute information set for the icon.

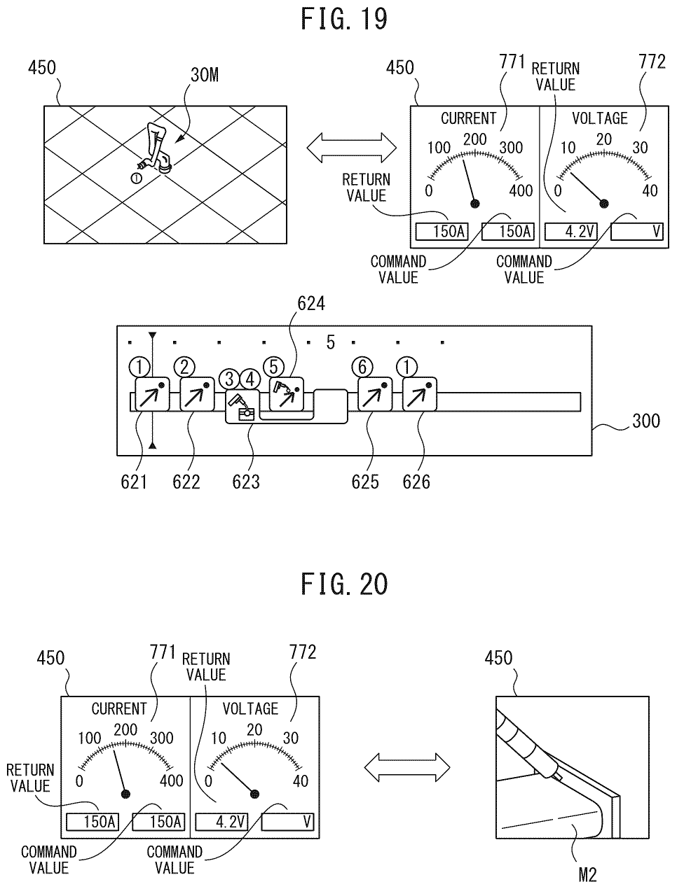

A display example of information using the display attribute information will be described with reference to FIG. 19. In a case of the example illustrated in FIG. 19, linear movement icons 621 and 622, a welding activation icon 623, a welding point movement icon 624, and linear movement icons 625 and 626 are disposed as a welding program in a program creation region 300. The welding activation icon 623 represents a command for activating the welding power source device. Further, the welding activation icon 623 has a long band shape and represents that the icon (welding point movement icon 624) disposed in the welding activation icon 623 is executed during welding. By an execution instruction on the icons (welding program), a welding operation of moving from an initial position to a welding waiting position, starting welding, and returning to the initial position again after the welding ends is performed.

The display attribute information is assumed to be set for the icons described above as follows.
The linear movement icon: “operation”
The welding activation icon: “arc welding”

While the linear movement icon in which the display attribute information indicates “operation” is executed, the related information display control unit 117 acquires position information about a robot from the robot controller 50 in real time, and displays, as an example, a robot model 30M representing an operation of the robot in a state display region 450. During execution of the welding activation icon 623 in which the display attribute information indicates “arc welding”, the related information display control unit 117 switches a display content displayed in the state display region 450 to information indicating a welding state. An example in which indicator images 771 and 772 respectively indicating a current and a voltage during arc welding are displayed as the information indicating the welding state is illustrated herein. The related information display control unit 117 acquires a welding current and a welding voltage via the robot controller 50.

In this way, the display attribute information can be set for each icon, and thus information desired by a user can be displayed while automatically switching in response to a function of the icon without a need for a user operation.

Note that various examples of setting of a time for displaying information related to the icon, a point in time in which a display starts, and the like are possible. A timing of such an information display may also be able to be set. For example, setting in which a screen is not switched for three seconds after a welding command is executed may be performed on the welding activation icon 623. Further, priority may be able to be set for each piece of display attribute information. For example, in a case where high priority is set for the display attribute “arc welding”, when a conflict occurs in a display content needed to be displayed in the state display region 450, information having high priority can be preferentially displayed. The timing of the information display and the priority may also be able to be set as an attribute related to each of the icons via the attribute information setting unit 118.

In addition to the display attribute information, an execution state attribute may be further able to be set for each of the icons via the attribute information setting unit 118. A display example of information related to an icon according to an execution state attribute will be described with reference to FIG. 20. As an exemplification, “effective welding” or “ineffective welding” is assumed to be able to be set as the execution state attribute for the welding activation icon 623. When the execution state attribute is “effective welding” (i.e., when arc discharge is effective), the related information display control unit 117 displays, in the state display region 450, the indicator images 771 and 772 respectively indicating the current and the voltage of the arc welding. On the other hand, when the execution state attribute is “ineffective welding” (i.e., when the arc discharge is ineffective), the related information display control unit 117 displays, in the state display region 450, a live image of a processing portion of a welding torch tip portion.

By the configuration described above, when setting is effective welding, information about a current and a voltage desired by a user during arc welding can be provided, whereas, when setting is ineffective welding, a live image M2 in which a position of the welding torch tip portion can be confirmed can be provided as information desired by the user. Note that what kind of information is set according to an execution state attribute may also be able to be set (i.e., customized) via the attribute information setting unit 118.

In this way, execution state information can be set for each icon, and thus information desired by a user can be displayed while automatically switching in response to an execution state of the icon without a need for a user operation.

Note that the attribute information setting unit 118 may receive setting of various types of the attribute information described above via a user operation. Alternatively, various types of the attribute information may be input from an external device to the teaching device 10A or may be stored in the icon data storage unit 111 in advance. In the present second embodiment, the example of displaying information related to an icon in the state display region 450 has been described, but information related to an icon may be displayed in a pop-up display as in the case of the first embodiment.

While the present invention has been described above by using the typical embodiments, it may be understood by a person skilled in the art that changes, and various other changes, omissions, and additions can be made to each of the aforementioned embodiments without departing from the scope of the present invention.

In the embodiments described above, in the teaching device that can perform programming using an icon as a command representing a function constituting a control program of a robot, a configuration in which information related to a command (icon) being a target of selection or an execution instruction on the command (icon) disposed in the program creation screen is displayed in response to the selection or the execution instruction has been described. Various functions of displaying the information related to the command (icon) in response to the selection or the execution instruction in the embodiments described above can also be applied to a teaching device configured to perform programming by a statement based on a text as the command representing the function constituting the control program of the robot. In this case, the teaching device (screen generation unit) creates, as the program creation screen, a first region (command list display region) for displaying a list of statements, and a second region (program creation region) for disposing the statement selected from the first region and creating a program.

For example, the first region (command list display region) may be formed as a pop-up menu screen that displays a list of statements of:
“straight line”;
“each axis”;
“call HAND_OPEN”;
“call HAND_CLOSE”;
“vision detection”; and
“vision correction data acquisition”.

The statement “straight line” corresponds to a command for moving a control portion of the robot in a trajectory of a straight line. The statement “each axis” corresponds to a command for moving the robot in an operation of each axis. The statement “call HAND_OPEN” corresponds to a command for opening a hand. The statement “call HAND_CLOSE” corresponds to a command for closing the hand and holding an object. The statement “vision detection” corresponds to a command for capturing an object by a visual sensor. The statement “vision correction data acquisition” corresponds to a command for detecting a position of an object from a captured image.

A user selects a command from the first region (pop-up menu screen), disposes the command in the second region (program creation region), performs program creation, and specifies a detailed parameter of each statement as necessary. An example of a program described in the second region (program creation region) is illustrated below.
1. straight line position [1] 2000 mm/sec positioning;
2. ;
3. vision detection “A”;
4. vision correction data acquisition “A” vision register [1] jump label [100];
5. ;
6. !Handling;
7. straight line position [2] 2000 mm/sec smooth 100 vision correction, vision register [1] tool correction, position register [1];
8. straight line position [2] 500 mm/sec positioning vision correction, vision register [1];
9. call HAND_CLOSE;
10. straight line position [2] 2000 mm/sec smooth 100 vision correction, vision register [1] tool correction, position register [1];

The program described above detects a position of an object by the visual sensor (a camera A) moved to a predetermined position (first to fifth rows), and achieves an operation of holding the object while performing position correction of the robot, based on the detected position (sixth to tenth rows).

In this way, when the programming by a statement is performed, by a functional block configuration similar to the functional block illustrated in FIG. 6, the teaching device also provides a function similar to that of the embodiments described above with regard to a statement selected from the first region (command list display region) being disposed in the second region (program creation region) and program creation being performed. Then, the teaching device (related information display control unit) displays information related to a target statement as, for example, a pop-up screen in response to selection on the statement in the first region or the second region, or an execution instruction on the statement disposed in the second region.

In the embodiments described above, the example in which one pop-up screen is displayed has been mainly described, but, for example, when a plurality of icons are selected by a user operation or an execution instruction on the plurality of icons is performed, related information about each of the plurality of icons may be provided to a plurality of pop-up screens.

In the embodiments described above, the display form in which the program creation screen 500 is displayed in an aspect of one rectangular frame shape and the program creation region 300 and the icon display region 200 are included in the one rectangular frame is illustrated, but this is merely an example, and various examples of a screen display form of the program creation screen are also possible. For example, each of the program creation region 300 and the icon display region 200 may be displayed as a different window. In this case, each of the program creation region 300, the icon display region 200, and the pop-up screen 700 is displayed as a different window.

An arrangement of the functional blocks of the visual sensor controller, the robot controller, and the teaching device illustrated in FIGS. 2 and 4 is an example, and the arrangement of the functional blocks can be appropriately changed.

The functional blocks of the teaching device illustrated in FIG. 4 may be achieved by the processor of the teaching device executing various types of software stored in a storage device, or may be achieved by a configuration mainly based on hardware such as an application specific integrated circuit (ASIC).

### REFERENCE SIGNS LIST

1 Object
2 Work table
10 Teaching device
11 Processor
12 Memory
13 Display unit
14 Operating unit
15 Input-output interface
30 Robot
30M Robot model
31 Wrist flange
33, 33A Hand
40 Visual sensor controller
41 Processor
42 Memory
43 Input-output interface
50 Robot controller
51 Processor
52 Memory
53 Input-output interface
54 Operating unit
70 Visual sensor
71 Force sensor
100 Robot system
110 Program creation unit
111 Icon data storage unit
112 Screen generation unit
113 Operating input reception unit
114 Program generation unit
115 Execution unit
116 Parameter setting unit
117 Related information display control unit
118 Attribute information setting unit
200 Icon display region
300 Program creation region
401 Input image
402 Image processing unit
403 Calibration data storage unit
450 Robot model display region
501 Operation control unit
601 View icon
602 Operation (vision) icon
603 Linear movement icon
604 Press operation icon
605 Release icon
606 Waiting setting icon
607 Register icon
651 Execution tab
652 Detail tab
671 Cursor
700 Pop-up screen

1. A teaching device configured to create a control program of a robot comprising:
a screen generation unit configured to generate a program creation screen for performing program creation by a command representing a function constituting a control program of the robot; and
a related information display control unit configured to display, in response to selection or an execution instruction on a command disposed in the program creation screen, information related to a command being a target of the selection or the execution instruction.

2. The teaching device according to claim 1, wherein
the program creation screen includes a first region that displays a list of one or more commands representing a function constituting a control program of the robot, and a second region for creating the control program by disposing a command selected from the first region, and
the related information display control unit displays, in response to selection on a command in the first region or the second region or execution instruction on a command disposed in the second region, the information related to a command being the target.

3. The teaching device according to claim 1, wherein the related information display control unit displays, during selection of a command disposed in the program creation screen, information related to the command.

4. The teaching device according to claim 1, wherein the related information display control unit displays, in response to an execution instruction on a command disposed in the program creation screen, information related to a command being a target of the execution instruction at any point in time before execution, during execution, or after execution of the command.

5. The teaching device according to claim 4, wherein the related information display control unit displays information related to a state during execution of a command being a target of the execution instruction while the command is executed.

6. The teaching device according to claim 4, wherein the related information display control unit displays information related to an execution result of a command being a target of the execution instruction after the command is executed.

7. The teaching device according to claim 1, wherein the information related to a command being the target includes any of parameter setting information about the command, information about a sensor or equipment associated with the command, an execution result or a state during execution of the command, and an internal variable of a program according to the command.

8. The teaching device according to claim 7, wherein the sensor is a visual sensor.

9. The teaching device according to claim 7, wherein the sensor is a force sensor.

10. The teaching device according to claim 1, wherein the related information display control unit displays the information related to a command being the target in a pop-up display.

11. The teaching device according to claim 1, further comprising an attribute information setting unit configured to set, for the command, display attribute information that defines a display content needed to be displayed as the information related to the command, wherein
the related information display control unit determines a display content according to the display attribute information set for the command when the information related to the command is displayed in response to an execution instruction on the command.

12. The teaching device according to claim 11, wherein
the attribute information setting unit is further configured to set an execution state attribute being information related to an execution state of the command, and
the related information display control unit further determines a display content, based on the execution state attribute when the information related to the command is displayed in response to an execution instruction on the command.

13. The teaching device according to claim 1, wherein the command is represented by an icon or a statement.
